(19) United States
(12) Patent Application Publication
(10) Pub. No.: US 2023/0243389 A1
(43) Pub. Date: Aug. 3, 2023

(54) DAMPER DEVICE

(71) Applicant: EXEDY Corporation, Osaka (JP)

(72) Inventor: Hiroshi UEHARA, Osaka (JP)

(21) Appl. No.: 18/091,584

(22) Filed: Dec. 30, 2022

(30) Foreign Application Priority Data
Feb. 1, 2022 (JP) 2022-014056

(51) Int. Cl. F16D 13/68

(52) U.S. Cl. CPC F16D 13/68; F16D 2300/22

(57) ABSTRACT

A damper device includes a first rotor, a second rotor, and an elastic coupling part. The elastic coupling part has a first torsional characteristic, a second torsional characteristic, and a third torsional characteristic. The first torsional characteristic is exerted with a first stiffness in a first actuation range of a torsion angle that ranges differently on the positive side and on the negative side. The second torsional characteristic is exerted with a second stiffness, which is greater in magnitude than the first stiffness, in a second actuation range of the torsion angle that ranges on the positive side of the first actuation range. The third torsional characteristic is exerted with a third stiffness, which is greater in magnitude than the first stiffness and different in magnitude from the second stiffness, in a third actuation range of the torsion angle that ranges on the negative side of the first actuation range.

### CROSS-REFERENCE TO RELATED APPLICATIONS

This application claims priority to Japanese Patent Application No. 2022-014056 filed Feb. 1, 2022. The entire contents of that application are incorporated by reference herein in their entirety.

### TECHNICAL FIELD

The present invention relates to a damper device.

### BACKGROUND ART

A type of hybrid vehicle including an engine and an electric motor, for instance, uses such a damper device having a torque limiter function as described in Japan Laid-open Patent Application Publication No. 2011-226572 in order to prevent transmission of an excessive torque from an output side to an engine side in engine start and so forth.

The damper device described in Japan Laid-open Patent Application Publication No. 2011-226572 is provided with a damper part, including a pair of plates and a plurality of torsion springs, and a torque limiter disposed on an outer peripheral side of the damper part. The damper part and the torque limiter are coupled by rivets. Besides, a plate composing part of the torque limiter is fixed to a flywheel by bolts.

Here, a torque, transmitted between the damper part and the flywheel, is limited by the torque limiter, whereby transmission of an excessive torque is prevented therebetween.

The damper device in the hybrid vehicle is actuated mainly in a positive-side torsion angular range (hereinafter simply referred to as “positive side” on an as-needed basis) of torsional characteristics during engine operation in, for instance, traveling. By contrast, the damper device is actuated mainly in a negative-side torsion angular range (hereinafter simply referred to as “negative side” on an as-needed basis) of the torsional characteristics in engine start. Therefore, chances are that torsional characteristics required on the positive side are different from those required on the negative side.

For example, the torsional characteristics are required to be exerted with a low stiffness in a wide range of small torsion angles on the positive side. By contrast, the torsional characteristics are required to be exerted with a high stiffness in a range of large torsion angles on the positive side in case, for instance, a large torque is inputted from a tire side. On the other hand, a difference in stiffness between a first stage and a subsequent second stage of the torsional characteristics is required to be made small on the negative side so as to efficiently absorb vibrations in engine start. Therefore, the torsional characteristics are required to be exerted with a smaller stiffness in a range of large torsion angles on the negative side than in the range of large torsion angles on the positive side.

It is an object of the present invention to obtain appropriate torsional characteristics on both positive and negative sides depending on vehicle specifications.

### BRIEF SUMMARY

(1) A damper device according to the present invention includes a first rotor, a second rotor, and an elastic coupling part. The second rotor is rotatable relative to the first rotor. The elastic coupling part elastically couples the first rotor and the second rotor in a rotational direction. Besides, the elastic coupling part has a first torsional characteristic, a second torsional characteristic, and a third torsional characteristic. The first torsional characteristic is exerted with a first stiffness in a first actuation range of a torsion angle. The first actuation range ranges to both positive and negative sides of the torsion angle. The first actuation range ranges differently on the positive and negative sides of the torsion angle. The second torsional characteristic is exerted with a second stiffness in a second actuation range of the torsion angle. The second stiffness is greater in magnitude than the first stiffness. The second actuation range ranges on the positive side of the first actuation range. The third torsional characteristic is exerted with a third stiffness in a third actuation range of the torsion angle. The third stiffness is greater in magnitude than the first stiffness and is different in magnitude from the second stiffness. The third actuation range ranges on the negative side of the first actuation range.

In the present damper device, the first actuation range, in which the first torsional characteristic is exerted, ranges differently on the positive and negative sides of the torsion angle. For example, when the first actuation range is widened on the positive side of the torsion angle, some vehicle specifications achieve enhancement in performance of absorbing vibrations during engine operation. The present damper device has the second and third torsional characteristics, each of which is exerted with a greater stiffness than the first torsional characteristic, on the positive and negative sides of the first actuation range. Moreover, the stiffness in the second torsional characteristic and that in the third torsional characteristic are different from each other. Because of this, when the second torsional characteristic, ranging on the positive side, is configured to be exerted with as high a stiffness as possible, for instance, a torque inputted through tires can be effectively absorbed. On the other hand, when the third torsional characteristic, ranging on the negative side, is configured to be exerted with a high stiffness close in magnitude to the stiffness in the first torsional characteristic, a hybrid vehicle achieves enhancement in performance of absorbing vibrations in engine start.

(2) Preferably, the first actuation range is wider on the positive side than on the negative side. With this configuration, enhancement in performance of absorbing vibrations is achieved in engine-based traveling.

(3) Preferably, the second stiffness in the second torsional characteristic of the elastic coupling part is greater in magnitude than the third stiffness in the third torsional characteristic of the elastic coupling part. With this configuration, the torque inputted through tires can be sufficiently absorbed. Besides, when the present damper device is installed in a hybrid vehicle, vibrations can be effectively absorbed in engine start.

(4) Preferably, the elastic coupling part includes a first elastic part and a second elastic part. The first and second elastic parts are disposed in alignment in a circumferential direction and are actuated in parallel. The first elastic part has a fourth torsional characteristic and a fifth torsional characteristic. The second elastic part has a sixth torsional characteristic and a seventh torsional characteristic.

The fourth torsional characteristic is exerted with a fourth stiffness in a fourth actuation range of the torsion angle. The fourth actuation range ranges to both the positive and negative sides of the torsion angle. The fourth actuation range ranges differently on the positive and negative sides of the torsion angle. The fifth torsional characteristic is exerted with a fifth stiffness in a fifth actuation range of the torsion angle. The fifth stiffness is greater in magnitude than the fourth stiffness. The fifth actuation range includes an actuation range ranging on the positive side of the fourth actuation range and an actuation range ranging on the negative side of the fourth actuation range. The sixth torsional characteristic is offset from the fourth torsional characteristic in both a torsion angular direction and an input torque direction and is exerted with a sixth stiffness in a sixth actuation range of the torsion angle. The sixth actuation range ranges to both the positive and negative sides of the torsion angle. The seventh torsional characteristic is exerted with a seventh stiffness in a seventh actuation range of the torsion angle. The seventh stiffness is greater in magnitude than the sixth stiffness and is different in magnitude from the fifth stiffness. The seventh actuation range includes an actuation range ranging on the positive side of the sixth actuation range and an actuation range ranging on the negative side of the sixth actuation range.

(5) Preferably, the first rotor includes a first support portion and a second support portion. The second rotor includes a first accommodation portion and a second accommodation portion. The first accommodation portion is provided to be offset from the first support portion to a first side in the rotational direction. The second accommodation portion is provided to be offset from the second support portion to a second side in the rotational direction. The elastic coupling part includes a first elastic member and a second elastic member. The first elastic member elastically couples the first rotor and the second rotor in the rotational direction and is disposed in a preliminarily compressed state in both the first support portion and the first accommodation portion. The second elastic member elastically couples the first rotor and the second rotor in the rotational direction and is disposed in a preliminarily compressed state in both the second support portion and the second accommodation portion.

(6) Preferably, an angle at which the first accommodation portion is offset from the first support portion is equal to an angle at which the second accommodation portion is offset from the second support portion. Besides, the first and second elastic members are equal in stiffness.

(7) Preferably, the first elastic member includes a first coil spring and a first elastic body. The first elastic body is disposed in an interior of the first coil spring and is lesser in length than the first coil spring. On the other hand, the second elastic member includes a second coil spring and a second elastic body. The second elastic body is disposed in an interior of the second coil spring. The second elastic body is lesser in length than the second coil spring and is different in length from the first elastic body.

(8) Preferably, the first and second elastic bodies are resin members.

Overall, according to the present invention described above, it is possible to obtain appropriate torsional characteristics on both positive and negative actuation ranges of a damper device depending on vehicle specifications.

### BRIEF DESCRIPTION OF THE DRAWINGS

FIG. 1 is a cross-sectional view of a damper device according to a preferred embodiment of the present invention.

FIG. 2 is a front view of the damper device shown in FIG. 1.

FIG. 3 is a diagram showing a positional relation between an input-side plate and a hub flange.

FIG. 4A is a diagram showing a neutral condition.

FIG. 4B is a diagram showing a condition that compression of first resin members begins.

FIG. 4C is a diagram showing a condition that compression of second resin members begins.

FIG. 5 is a chart showing torsional characteristics of a damper unit.

FIG. 6 is a schematic diagram for explaining a series of actions performed in each of first window portions.

FIG. 7 is a schematic diagram for explaining a series of actions performed in each of second window portions.

FIG. 8 is a chart showing torsional characteristics of a damper unit in another preferred embodiment.

### DETAILED DESCRIPTION

### [Entire Configuration]

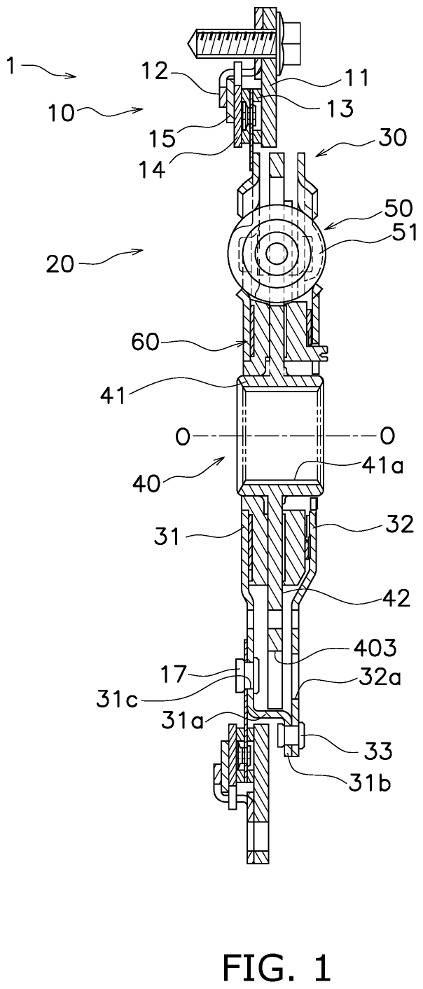

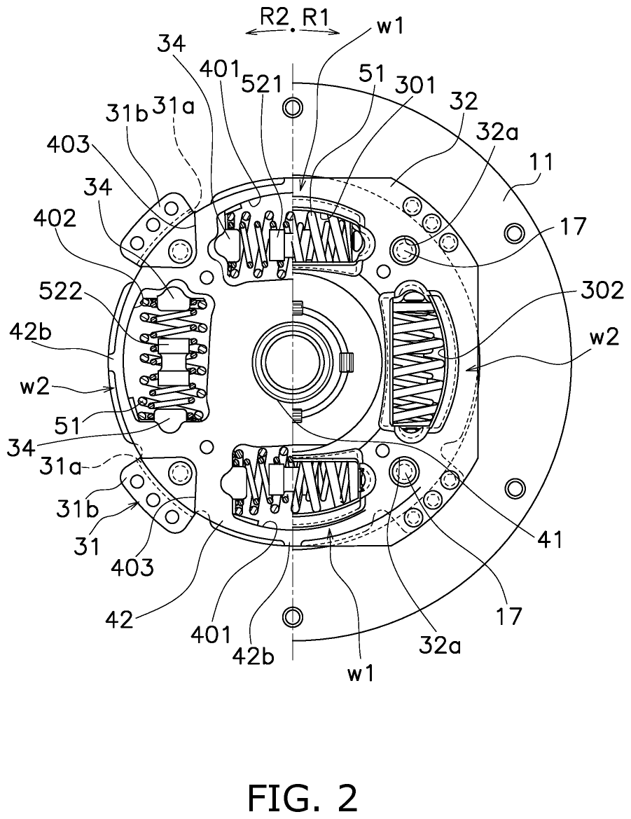

FIG. 1 is a cross-sectional view of a torque limiter embedded damper device 1 (hereinafter simply referred to as “damper device 1”) according to a preferred embodiment of the present invention. On the other hand, FIG. 2 is a front view of the damper device 1, from part of which some constituent members are detached. In FIG. 1, an engine (not shown in the drawing) is disposed on the left side of the damper device 1, whereas a drive unit (not shown in the drawing), including an electric motor, a transmission, and so forth, is disposed on the right side of the damper device 1.

It should be noted that in the following explanation, the term “axial direction” refers to an extending direction of a rotational axis O of the damper device 1. On the other hand, the term “circumferential direction” refers to a circumferential direction of an imaginary circle about the rotational axis O, whereas the term “radial direction” refers to a radial direction of the imaginary circle about the rotational axis O. It should be noted that the circumferential direction is not required to be perfectly matched with that of the imaginary circle about the rotational axis O. Likewise, the radial direction is not required to be perfectly matched with a diameter direction of the imaginary circle about the rotational axis O.

The damper device 1 is a device provided between a flywheel (not shown in the drawings) and an input shaft of the drive unit in order to limit a torque transmitted between the engine and the drive unit and attenuate rotational fluctuations. The damper device 1 includes a torque limiter unit 10 and a damper unit 20.

### [Torque Limiter Unit 10]

The torque limiter unit 10 is disposed on the outer peripheral side of the damper unit 20. The torque limiter unit 10 limits the torque transmitted between the flywheel and the damper unit 20. The torque limiter unit 10 includes a cover plate 11, a support plate 12, a friction disc 13, a pressure plate 14, and a cone spring 15.

### [Damper Unit 20]

The damper unit 20 includes an input-side plate 30 (exemplary first rotor), a hub flange 40 (exemplary second rotor), an elastic coupling part 50, and a hysteresis generating mechanism 60.

### <Input-Side Plate 30>

The input-side plate 30 includes a first plate 31 and a second plate 32. The first and second plates 31 and 32, each of which is made in shape of a disc including a hole in the center part thereof, are disposed apart from each other at an interval in the axial direction. The first plate 31 includes four stopper portions 31a and four fixation portions 31b in the outer peripheral part thereof. Besides, each of the first and second plates 31 and 32 includes a pair of first support portions 301 and a pair of second support portions 302. The first and second support portions 301 and 302 provided in the first plate 31 are identical in position to those provided in the second plate 32. Besides, the first plate 31 is provided with holes 31c for rivets 17, whereas the second plate 32 is provided with assembling holes 32a in corresponding positions to the holes 31c. The friction disc 13 of the torque limiter unit 10 is fixed at the inner peripheral part thereof to the first plate 31 by the rivets 17 passing through the assembling holes 32a.

The stopper portions 31a are formed by bending the outer peripheral part of the first plate 31 toward the second plate 32 and extend in the axial direction. The fixation portions 31b are formed by bending the distal ends of the stopper portions 31a radially outward. The fixation portions 31b are fixed to the outer peripheral end of the second plate 32 by a plurality of rivets 33. Because of this, the first and second plates 31 and 32 are non-rotatable relative to each other and are axially immovable from each other.

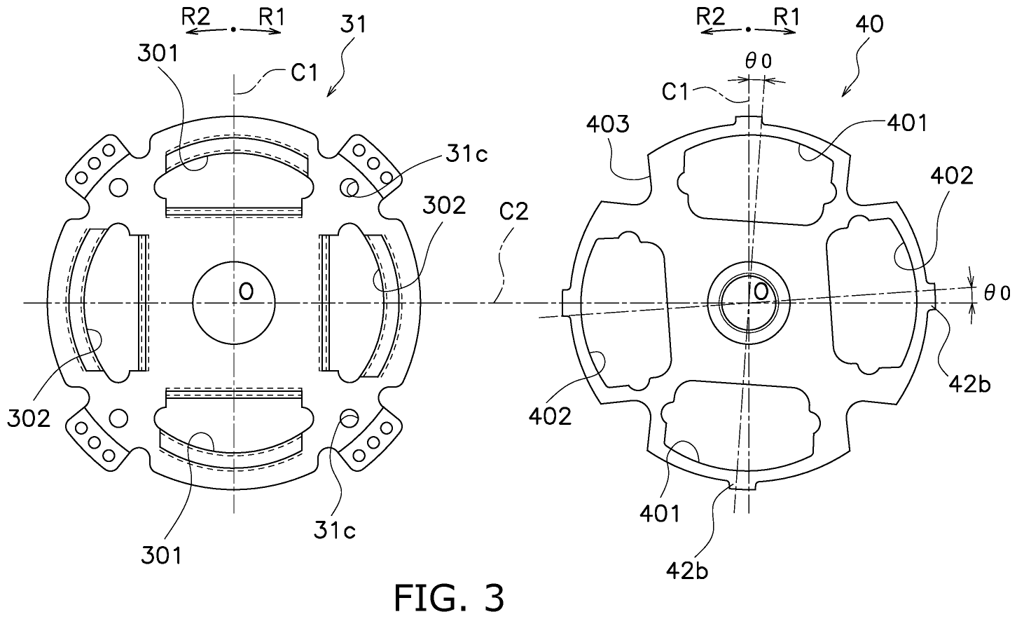

As shown in FIG. 2 and FIG. 3 including the first plate 31 extracted from FIG. 2, the first support portions 301, provided as a pair, are disposed in opposition to each other relative to the rotational axis O. On the other hand, the second support portions 302, provided as a pair, are disposed in opposition to each other relative to the rotational axis O, while being displaced from the first support portions 301 at angular intervals of 90°. The support portions 301 and 302 are identical in shape to each other; each includes a hole axially penetrating therethrough and an edge part formed by cutting and raising the inner and outer peripheral edges of the hole.

### <Hub Flange 40>

As shown in FIGS. 1 and 2, the hub flange 40 includes a hub 41 and a flange 42. The hub flange 40 is rotatable relative to the input-side plate 30 in a predetermined angular range. The hub 41 has a tubular shape and is provided with a spline hole 41a in the center part thereof. Besides, the hub 41 penetrates both holes provided in the center parts of the first and second plates 31 and 32. The flange 42 has a disc shape and is shaped to extend radially outward from the outer peripheral surface of the hub 41. The flange 42 is disposed axially between the first and second plates 31 and 32.

The flange 42 includes four stopper protrusions 42b, a pair of first accommodation portions 401, a pair of second accommodation portions 402, and four cutouts 403.

The four stopper protrusions 42b are shaped to protrude radially outward from the outer peripheral surface of the flange 42. Each stopper protrusion 42b is provided in a position located radially outside the circumferential middle of each accommodation portion 401, 402. Now, when the input-side plate 30 and the hub flange 40 are rotated relative to each other, the stopper protrusions 42b contact the stopper portions 31a of the first plate 31; accordingly, relative rotation is prevented between the input-side plate 30 and the hub flange 40.

As shown in FIG. 2 and FIG. 3 including the hub flange 40 extracted from FIG. 2, the first accommodation portions 401, provided as a pair, are disposed in opposition to each other relative to the rotational axis O. On the other hand, the second accommodation portions 402, provided as a pair, are disposed in opposition to each other relative to the rotational axis O, while each is disposed circumferentially between the first accommodation portions 401. The accommodation portions 401 and 402 are identical in shape to each other; each is an approximately rectangular hole that the outer peripheral part thereof is made in shape of a circular arc.

Each of the four cutouts 403 is provided circumferentially between adjacent two accommodation portions 401 and 402 and is recessed radially inward from the outer peripheral surface of the flange 42 at a predetermined depth. The cutouts 403 are provided in corresponding positions to the rivets 17 by which the first plate 31 and the friction disc 13 of the torque limiter unit 10 are coupled to each other. Therefore, the torque limiter unit 10 and the damper unit 20, assembled in different steps, can be fixed to each other by the rivets 17 with use of the assembling holes 32a of the second plate 32 and the cutouts 403 of the flange 42.

### <Layout of Support Portions and Accommodation Portions>

FIG. 3 shows a positional relation of the hub flange 40 with respect to the input-side plate 30 (herein the first plate 31) in the neutral condition. In FIG. 3, straight line C1 is an imaginary line that passes through the rotational axis O and the centers of the pair of first support portions 301. On the other hand, straight line C2 is an imaginary line that passes through the rotational axis O and the centers of the pair of second support portions 302. In an assembled condition, the input-side plate 30 and the hub flange 40 are assembled to overlap with each other, while the positional relation shown in FIG. 3 is maintained. The term “neutral condition” herein refers to a condition that an angle of relative rotation between the input-side plate 30 and the hub flange 40 is 0° (i.e., a condition made at a torsion angle of 0° without torsion therebetween).

The pair of first accommodation portions 401 is disposed in corresponding positions to the pair of first support portions 301. On the other hand, the pair of second accommodation portions 402 is disposed in corresponding positions to the pair of second support portions 302. In more detail, the pair of first accommodation portions 401 is disposed to overlap in part with the pair of first support portions 301 and be offset (or displaced) from the pair of first support portions 301 to a first side in a rotational direction (hereinafter simply referred to as “R1 side”) by an angle θ0 as seen in the axial direction. In other words, the pair of first accommodation portions 401 is disposed to be offset to the R1 side by the angle θ0 from the straight line C1. On the other hand, the pair of second accommodation portions 402 is disposed to overlap in part with the pair of second support portions 302 and be offset from the pair of second support portions 302 to a second side in the rotational direction (hereinafter simply referred to as “R2 side”) by the angle θ0 as seen in the axial direction. In other words, the pair of second accommodation portions 402 is disposed to be offset to the R2 side by the angle θ0 from the straight line C2.

### <Spring Seats 34>

Spring seats 34, provided as a pair, are attached to each axially opposed pair of first support portions 301 and each first accommodation portion 401 (hereinafter collectively referred to as “first window portion w1” on an as-needed basis), while in opposition to each other; likewise, spring seats 34, provided as a pair, are attached to each axially opposed pair of second support portions 302 and each second accommodation portion 402 (hereinafter collectively referred to as “second window portion w2” on an as-needed basis), while in opposition to each other (see FIG. 2).

A condition that the spring seats 34 are disposed in each window portion w1, w2 will be herein assumed. Under the condition, when the entirety of each axially opposed pair of first support portions 301 of the first-side plate 30 and the entirety of each first accommodation portion 401 of the hub flange 40 overlap with each other as seen in the axial direction (i.e., when an offset angle is “0”), the distance between the spring seats 34 opposed to each other (exactly speaking, the distance between contact surfaces at which the opposed spring seats 34 are in contact with the end surfaces of each coil spring 51) is set to be L. Likewise, when the entirety of each axially opposed pair of second support portions 302 and the entirety of each second accommodation portion 402 overlap with each other as seen in the axial direction, the distance between the spring seats 34 opposed to each other is set to be L.

### <Elastic Coupling Part 50>

The elastic coupling part 50 includes a first elastic part 501 and a second elastic part 502 that are disposed in alignment with each other in the circumferential direction. The first and second elastic parts 501 and 502 are actuated in parallel. The first elastic part 501 includes two coil springs 51 and two first resin members 521 (exemplary first elastic body). The second elastic part 502 includes two coil springs 51 and two second resin members 522 (exemplary second elastic body).

All the coil springs 51 are equal in stiffness (k0). Each coil spring 51 is composed of an outer spring and an inner spring disposed in the interior of the outer spring. The four coil springs 51 are accommodated in the accommodation portions 401 and 402 of the flange 42, respectively, while being supported in both radial and axial directions by the support portions 301 and 302 of the input-side plate 30, respectively. The coil springs 51 are actuated in parallel. Incidentally, the four coil springs 51 are equal in free length (Sf). The free length Sf of each coil spring 51 is equal in magnitude to the distance L between the opposed spring seats 34 attached to each window portion w1, w2 (exactly speaking, the distance between the contact surfaces at which the opposed spring seats 34 are in contact with the end surfaces of each coil spring 51) in the condition made when the offset angle is “0”.

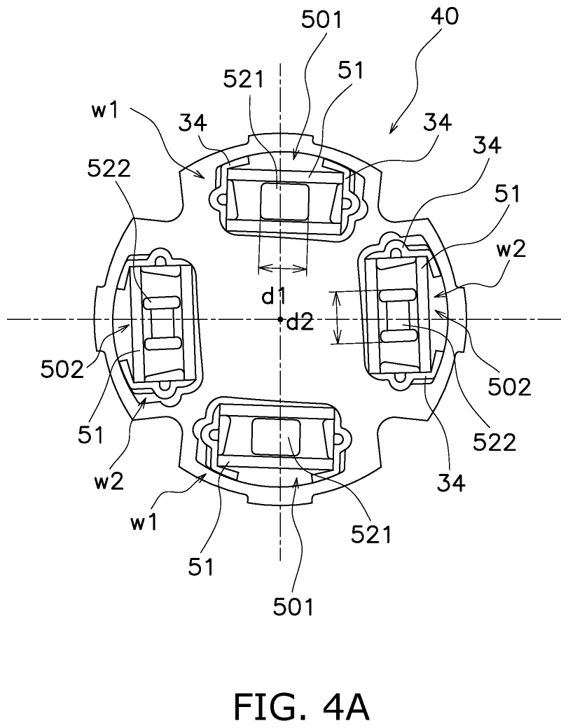

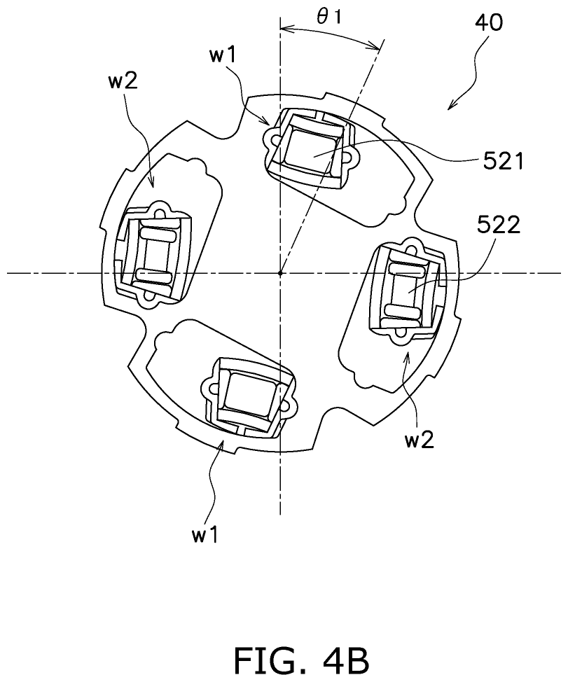

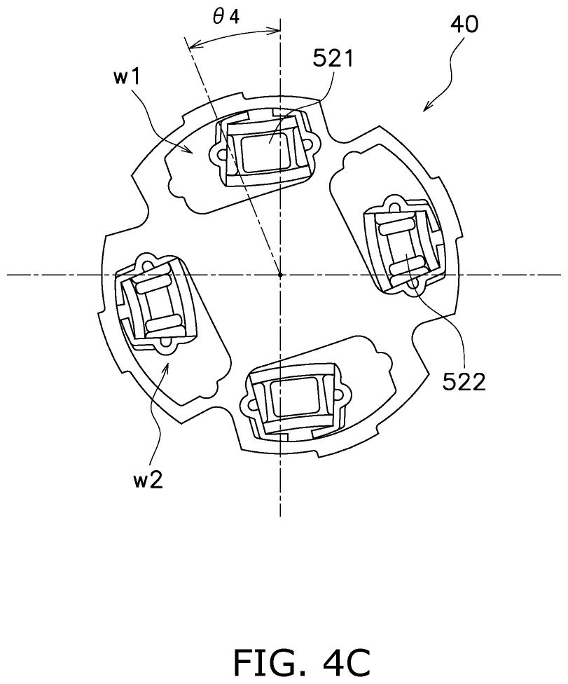

As shown in FIG. 4A, each first resin member 521 is disposed in the interior of the coil spring 51 in each first window portion w1. On the other hand, each second resin member 522 is disposed in the interior of the coil spring 51 in each second window portion w2. Each first resin member 521 is made in shape of a column. The length of each first resin member 521 is set to be d1, while the stiffness thereof is set to be k1. Each second resin member 522 is roughly made in shape of a column composed of large diameter portions provided as both end portions thereof and a small diameter portion provided as a middle portion thereof. The length of each second resin member 522 is set to be d2, while the stiffness thereof is set to be k2. Here, the relation in length and that in stiffness among each coil spring 51, each first resin member 521, and each second resin member 522 are set as follows.

d1<d2<Sf

k1>k2>k0

### <Accommodation States of Coil Springs 51>

Now, a state of each coil spring 51 accommodated in each window portion w1, w2 in the neutral condition will be hereinafter explained in detail.

As described above, in the neutral condition, the pair of first accommodation portions 401 is offset from the axially opposed pairs of first support portions 301 to the R1 side by the angle θ0. On the other hand, the pair of second accommodation portions 402 is offset from the axially opposed pairs of second support portions 302 to the R2 side by the angle θ0. Besides, each coil spring 51 is attached in a compressed state to an opening (axially penetrating hole) formed by axial overlap between each axially opposed pair of support portions 301, 302 and each corresponding accommodation portion 401, 402.

### (Torsional Characteristics)

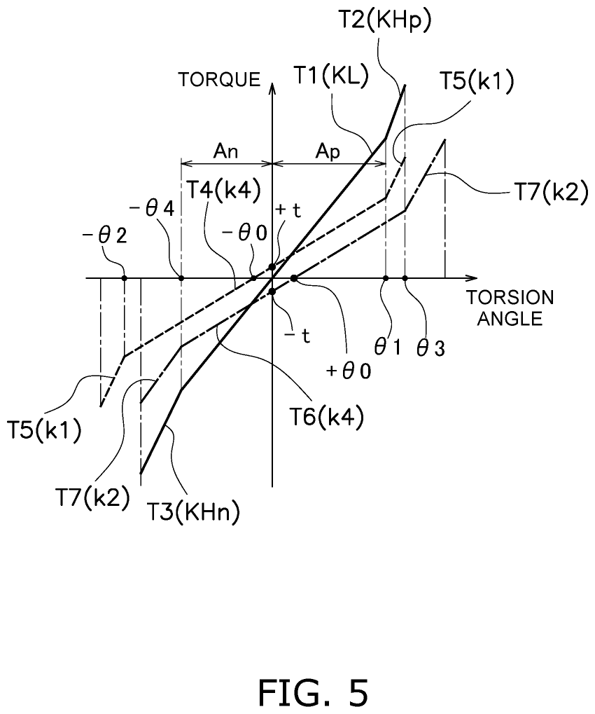

FIG. 5 is a chart showing torsional characteristics (in which hysteresis torques are not considered), wherein the horizontal axis indicates torsion angle, while the vertical axis indicates torque. In FIG. 5, a broken line indicates torsional characteristics exerted in the first window portions w1; a dashed dotted line indicates torsional characteristics exerted in the second window portions w2; a solid line indicates net torsional characteristics obtained by adding the torsional characteristics exerted in the first window portions w1 and those exerted in the second window portions w2 as torsional characteristics of the damper unit 20.

As is obvious from the torsional characteristics depicted with the solid line in FIG. 5, the damper unit 20 according to the present preferred embodiment has a first torsional characteristic T1 exerted with a low stiffness, a second torsional characteristic T2 exerted with a high stiffness on the positive side of torsion angle, a third torsional characteristic T3 exerted with a high stiffness on the negative side of torsion angle. The first torsional characteristic T1 is exerted with a first stiffness KL in a first actuation range of torsion angle that ranges to both the positive and negative sides of torsion angle. Besides, in the first actuation range, a positive-side range Ap is set to be wider than a negative-side range An. The second torsional characteristic T2 is exerted with a second stiffness KHp greater in magnitude than the first stiffness KL in a second actuation range of torsion angle that ranges on the positive side of the first actuation range. The third torsional characteristic T3 is exerted with a third stiffness KHn, which is greater in magnitude than the first stiffness KL and is lesser in magnitude than the second stiffness KHp, in a third actuation range of torsion angle that ranges on the negative side of the first actuation range. The relation in actuation range and that in stiffness are set as follows.

Ap>An

KL<KHn<KHp

### [Actions]

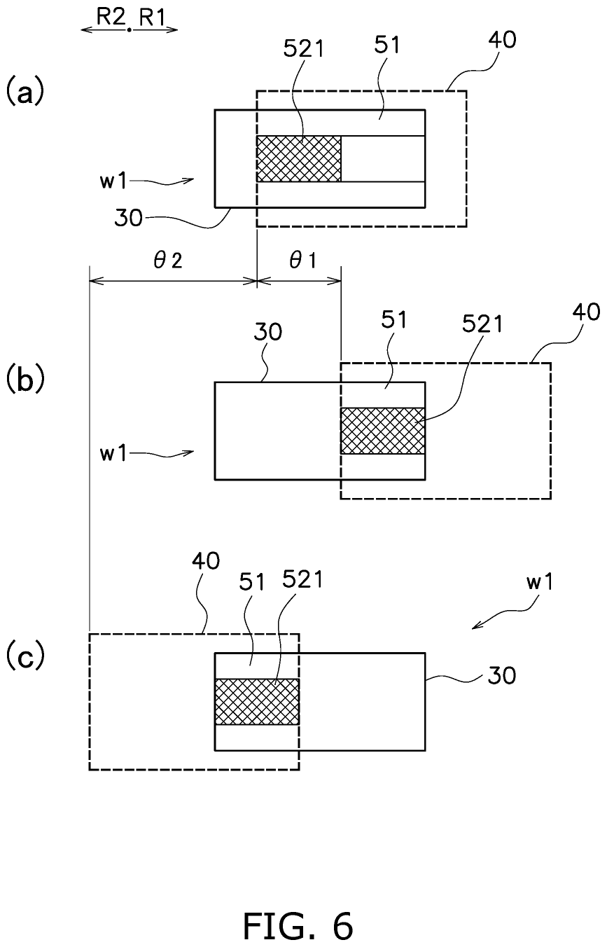

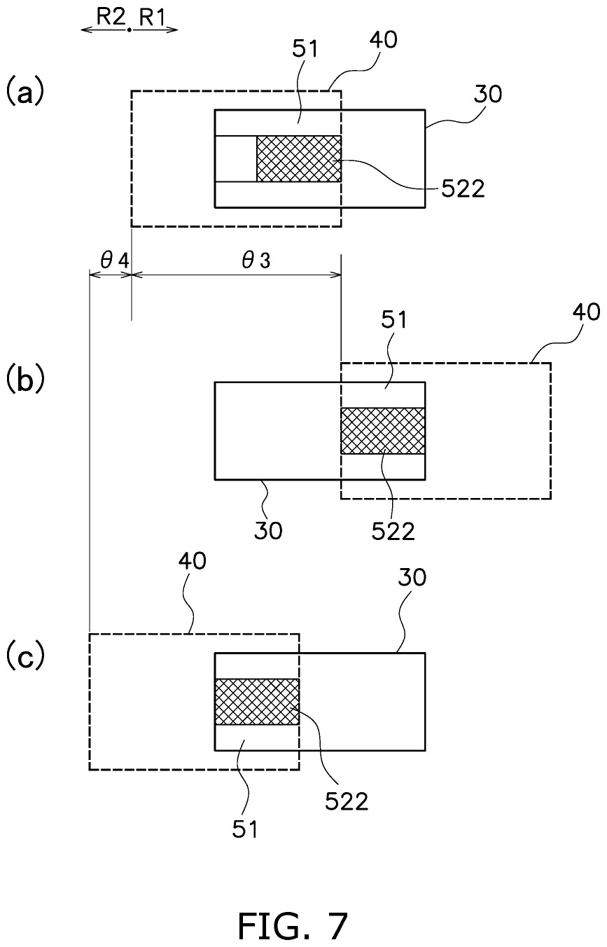

A series of actions performed in each window portion w1, w2 will be explained in detail; however, hysteresis torques will not be considered in the following explanation. FIG. 6 is a schematic diagram for explaining a series of actions performed in each first window portion w1, whereas FIG. 7 is a schematic diagram for explaining a series of actions performed in each second window portion w2.

<First Window Portions w1>

FIG. 4A and diagram (a) in FIG. 6 show the neutral condition that relative rotation is not being caused between the input-side plate 30 and the hub flange 40. Besides, FIG. 4B and diagram (b) in FIG. 6 show a condition that torsion of the hub flange 40 with respect to the input-side plate 30 is caused from the neutral condition to the R1 side, whereby compression of the first resin member 521 begins. By contrast, diagram (c) in FIG. 6 shows a condition that torsion of the hub flange 40 with respect to the input-side plate 30 is reversely caused from the neutral condition to the R2 side, whereby compression of the first resin member 521 begins. It should be noted that in the following explanation, the angle of torsion of the hub flange 40 with respect to the input-side plate 30 will be simply referred to as “torsion angle” on an as-needed basis.

First, in the neutral condition, the axially opposed pair of first support portions 301 and the first accommodation portion 401 are disposed to be offset from each other in each first window portion w1; hence, the distance between the spring seats 34 opposed to each other in each first window portion w1 is lesser in magnitude than the free length Sf of the coil spring 51. Therefore, in the neutral condition, a torsional torque +t is generated by the compressed coil springs 51 as depicted with the broken line in FIG. 5.

Then, the coil spring 51 is constantly compressed in an R1-side torsion angular range of 0° to θ1 at which compression of the first resin member 521 begins. Therefore, a relatively-low-stiffness torsional characteristic T4 (exemplary fourth torsional characteristic) is exerted with a stiffness k4 (exemplary fourth stiffness) of two coil springs 51 in the torsion angular range of 0 to θ1.

Next, when the first resin member 521 contacts at both end surfaces thereof with the contact surfaces of the spring seats 34 opposed to each other (see diagram (b) in FIG. 6), a high-stiffness torsional characteristic T5 (exemplary fifth torsional characteristic) is exerted with a stiffness k1 (exemplary fifth stiffness) of the first resin members 521 at the torsion angle θ1 and thereafter.

On the other hand, when torsion of the hub flange 40 with respect to the input-side plate 30 is caused from the neutral condition to the R2 side by the offset angle θ0, the distance between the pair of spring seats 34 supporting the coil spring 51 becomes L that is equal in magnitude to the free length Sf of the coil spring 51. Therefore, when the angle of torsion between the input-side plate 30 and the hub flange 40 is −θ0, the torsional torque becomes “0” as depicted with the broken line in FIG. 5.

Moreover, when torsion of the hub flange 40 is caused to the R2 side at a greater angle than the offset angle θ0, the distance between the pair of spring seats 34 supporting the coil spring 51 again becomes lesser in magnitude than the free length Sf of the coil spring 51. Therefore, when the torsion angle becomes greater than −θ0 to the negative side, the coil spring 51 is compressed from the free-length-Sf state thereof, whereby a torsional characteristic similar to that exerted on the positive side is obtained by two coil springs 51.

Then, when the torsion angle becomes −θ2 as shown in diagram (c) in FIG. 6, the first resin member 521 contacts at both end surfaces thereof with the contact surfaces of the spring seats 34 opposed to each other. At the torsion angle −θ2 and thereafter, a high-stiffness torsional characteristic T5 (exemplary fifth torsional characteristic) is exerted with a stiffness k1 (exemplary fifth stiffness) of the rein members 521 in a similar manner to the above.

<Second Window Portions w2>

FIG. 4A and diagram (a) in FIG. 7 show the neutral condition that relative rotation is not being caused between the input-side plate 30 and the hub flange 40. Besides, diagram (b) in FIG. 7 shows a condition that torsion of the hub flange 40 with respect to the input-side plate 30 is caused from the neutral condition to the R1 side, whereby compression of the second resin member 522 begins. By contrast, FIG. 4C and diagram (c) in FIG. 7 show a condition that torsion of the hub flange 40 with respect to the input-side plate 30 is reversely caused from the neutral condition to the R2 side, whereby compression of the second resin member 522 begins.

In the neutral condition, the axially opposed pair of second support portions 302 and the second accommodation portion 402 are disposed to be offset from each other in each second window portion w2 as similarly seen in each first window portion w1; hence, the distance between the spring seats 34 opposed to each other in each second window portion w2 is lesser in magnitude than the free length Sf of the coil spring 51. Therefore, in the neutral condition, a torsional torque −t is generated by the compressed coil springs 51 as depicted with the dashed dotted line in FIG. 5.

When a torque is inputted to the damper unit 20 and thereby torsion of the hub flange 40 with respect to the input-side plate 30 is caused from the neutral condition to the R1 side by the offset angle θ0, the entirety of the axially opposed pair of first support portions 301 and that of the first accommodation portion 401 overlap with each other as seen in the axial direction, whereby the distance between the spring seats 34 opposed to each other becomes L that is equal in magnitude to the free length Sf of the coil spring 51. Therefore, in this condition, the torsional torque becomes “0” as depicted with the dashed dotted line in FIG. 5.

Moreover, torsion of the hub flange 40 is caused to the R1 side at a greater angle than the offset angle θ0, the distance between the pair of spring seats 34 supporting the coil spring 51 again becomes lesser in magnitude than the free length Sf of the coil spring 51. Therefore, when the torsion angle becomes greater than θ0, the coil spring 51 is compressed from the free-length-Sf state thereof, whereby a low-stiffness torsional characteristic T6 (exemplary sixth torsional characteristic) is exerted with the stiffness k4 (exemplary sixth stiffness) of two coil springs 51.

Next, as shown in diagram (b) in FIG. 7, when the torsion angle becomes θ3 and the second resin member 522 contacts at both end surfaces thereof with the contact surfaces of the spring seats 34 opposed to each other, a high-stiffness torsional characteristic T7 (exemplary seventh torsional characteristic) is exerted with a stiffness k2 (exemplary seventh stiffness) of the second resin members 522 at the torsion angle θ3 and thereafter.

On the other hand, when torsion of the hub flange 40 is caused from the neutral condition to the R2 side, the coil spring 51 is constantly compressed. Therefore, a relatively-low-stiffness torsional characteristic is exerted with the stiffness k4 of the two coil springs 51 in a negative-side torsion angular range from 0° to −θ4, at which compression of the second resin member 522 begins, as similarly seen on the positive side of torsion angle.

Next, as shown in FIG. 4C and diagram (c) in FIG. 7, when the second resin member 522 contacts at both end surfaces thereof with the contact surfaces of the spring seats 34 opposed to each other, a high-stiffness torsional characteristic T7 (exemplary seventh torsional characteristic) is exerted with a stiffness k2 (exemplary seventh stiffness) of the second resin members 522 at the torsion angle −θ4 and thereafter as depicted with the dashed dotted line in FIG. 5.

### <Net Torsional Characteristic>

As described above, the entire damper unit exerts torsional characteristics (depicted with the solid line in FIG. 5) obtained, as the net torsional characteristics, by adding the torsional characteristics exerted in the first window portions w1 (depicted with broken line in FIG. 5) and the torsional characteristics exerted in the second window portions w2 (depicted with the dashed dotted line in FIG. 5). In other words, the torsional torque is “0” in the neutral condition; the relatively-low-stiffness first torsional characteristic T1 is exerted with the first stiffness KL in the first actuation range (the torsion angular range of −θ4 to +θ1); the high-stiffness second torsional characteristic T2 is exerted with the second stiffness KHp in the second actuation range (the positive-side torsion angular range exceeding +θ1); the high-stiffness third torsional characteristic T3 is exerted with the third stiffness KHn in the third actuation range (the negative-side torsion angular range exceeding −θ4).

Here, suppose that each first resin member 521 and each second resin member 522 are designed to be equal in entire length. In this case, +θ1 and −θ4 in FIG. 5 are made equal in absolute value. Therefore, the positive-side and negative-side actuation ranges for the low-stiffness torsional characteristic are made equal in the net torsional characteristics.

However, in the present preferred embodiment, each first resin member 521 and each second resin member 522 are different in entire length from each other; hence, as shown in FIG. 5, the torsion angular range of 0 to +θ1 and the torsion angular range of 0 to −θ4 are different from each other. Consequently, the positive-side and negative-side actuation ranges, composing the first actuation range for the low-stiffness torsional characteristic, are different from each other in the net torsional characteristics. Specifically, the positive-side actuation range is wider than the negative-side actuation range in the first actuation range.

### Other Preferred Embodiments

The present invention is not limited to the preferred embodiment described above, and a variety of changes or modifications can be made without departing from the scope of the present invention.

(a) When the length of each first resin member and that of each second resin member are suitably set, it is possible to change, in a torsion angular direction, the amount of offset between the torsional characteristics exerted in the first window portions w1 and those exerted in the second window portions w2.

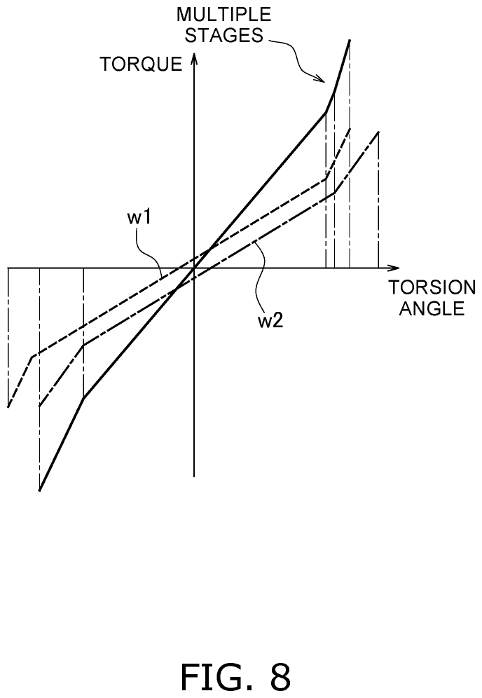

For example, as shown in FIG. 8, when a high-stiffness part of the torsional characteristics exerted in the first window portions w1 (see a broken line) and that of the torsional characteristics exerted in the second window portions w2 (see a dashed dotted line) are overlapped in part on the positive side of torsion angle, a high-stiffness part of the net torsional characteristics can be multistage on the positive side of torsion angle.

(b) In the preferred embodiment described above, each elastic part is composed of the coil springs and the resin members; however, high-stiffness coil springs can be used instead of the resin members in each elastic part.

(c) The number of accommodation portions, that of support portions, that of coil springs, and that of resin members are exemplary only and are not limited to those in the preferred embodiment described above.

### REFERENCE SIGNS LIST

1 Damper device
30 Input-side plate (first rotor)
301, 302 First/second support portion
40 Hub flange (second rotor)
401, 402 First/second accommodation portion
50 Elastic coupling part
501, 502 First/second elastic part
51 Coil spring (first/second elastic member)
521, 522 First/second resin member

What is claimed is:

1. A damper device comprising:
a first rotor;
a second rotor rotatable relative to the first rotor; and
an elastic coupling part configured to elastically couple the first rotor and the second rotor in a rotational direction,
the elastic coupling part having
a first torsional characteristic exerted with a first stiffness in a first actuation range of a torsion angle, the first actuation range ranging to both positive and negative sides of the torsion angle, the first actuation range ranging differently on the positive and negative sides of the torsion angle,
a second torsional characteristic exerted with a second stiffness in a second actuation range of the torsion angle, the second stiffness greater in magnitude than the first stiffness, the second actuation range ranging on the positive side of the first actuation range, and
a third torsional characteristic exerted with a third stiffness in a third actuation range of the torsion angle, the third stiffness greater in magnitude than the first stiffness, the third stiffness different in magnitude from the second stiffness, the third actuation range ranging on the negative side of the first actuation range.

2. The damper device according to claim 1, wherein the first actuation range is wider on the positive side than on the negative side.

3. The damper device according to claim 1, wherein the second stiffness in the second torsional characteristic of the elastic coupling part is greater in magnitude than the third stiffness in the third torsional characteristic of the elastic coupling part.

4. The damper device according to claim 1, wherein
the elastic coupling part includes a first elastic part and a second elastic part, the first and second elastic parts aligned in a circumferential direction, the first and second elastic parts actuated in parallel,
the first elastic part has
a fourth torsional characteristic exerted with a fourth stiffness in a fourth actuation range of the torsion angle, the fourth actuation range ranging to both the positive and negative sides of the torsion angle, the fourth actuation range ranging differently on the positive and negative sides of the torsion angle, and
a fifth torsional characteristic exerted with a fifth stiffness in a fifth actuation range of the torsion angle, the fifth stiffness greater in magnitude than the fourth stiffness, the fifth actuation range including an actuation range ranging on the positive side of the fourth actuation range and an actuation range ranging on the negative side of the fourth actuation range, and
the second elastic part has
a sixth torsional characteristic offset from the fourth torsional characteristic in both a torsion angular direction and an input torque direction, the sixth torsional characteristic exerted with a sixth stiffness in a sixth actuation range of the torsion angle, the sixth actuation range ranging to both the positive and negative sides of the torsion angle, and
a seventh torsional characteristic exerted with a seventh stiffness in a seventh actuation range of the torsion angle, the seventh stiffness greater in magnitude than the sixth stiffness, the seventh stiffness different in magnitude from the fifth stiffness, the seventh actuation range including an actuation range ranging on the positive side of the sixth actuation range and an actuation range ranging on the negative side of the sixth actuation range.

5. The damper device according to claim 1, wherein
the first rotor includes a first support portion and a second support portion,
the second rotor includes a first accommodation portion and a second accommodation portion, the first accommodation portion provided to be offset from the first support portion to a first side in the rotational direction, the second accommodation portion provided to be offset from the second support portion to a second side in the rotational direction, and
the elastic coupling part includes
a first elastic member configured to elastically couple the first rotor and the second rotor in the rotational direction, the first elastic member disposed in a preliminarily compressed state in both the first support portion and the first accommodation portion, and
a second elastic member configured to elastically couple the first rotor and the second rotor in the rotational direction, the second elastic member disposed in a preliminarily compressed state in both the second support portion and the second accommodation portion.

6. The damper device according to claim 5, wherein
an angle at which the first accommodation portion is offset from the first support portion is equal to an angle at which the second accommodation portion is offset from the second support portion, and
the first and second elastic members are equal in stiffness.

7. The damper device according to claim 5, wherein
the first elastic member includes a first coil spring and a first elastic body, the first elastic body disposed in an interior of the first coil spring, the first elastic body lesser in length than the first coil spring, and
the second elastic member includes a second coil spring and a second elastic body, the second elastic body disposed in an interior of the second coil spring, the second elastic body lesser in length than the second coil spring, the second elastic body different in length from the first elastic body.

8. The damper device according to claim 7, wherein the first and second elastic bodies are resin members.
